(19) United States
(12) Patent Application Publication
(10) Pub. No.: US 2025/0085510 A1
(43) Pub. Date: Mar. 13, 2025

(54) Lens Assembly

(71) Applicants: Sintai Optical (Shenzhen) Co., Ltd., ShenZhen City (CN); Asia Optical Co., Inc., Taichung (TW)

(72) Inventor: Yuan-Chen Chen, Taichung (TW)

(21) Appl. No.: 18/817,385

(22) Filed: Aug. 28, 2024

(30) Foreign Application Priority Data
Sep. 7, 2023 (TW) 112134075
Jul. 5, 2024 (CN) 202410902086.0

(51) Int. Cl. G02B 13/00; G02B 9/12

(52) U.S. Cl. CPC G02B 13/0035; G02B 9/12

(57) ABSTRACT

A lens assembly includes a first lens, a second lens, and a third lens. The first lens is a meniscus lens with positive refractive power and includes a convex surface facing an object side and a concave surface facing an image side. The second lens is with positive refractive power and includes a convex surface facing the image side. The third lens is with refractive power and includes a concave surface facing the image side. The first lens, the second lens, and the third lens are arranged in order from the object side to the image side along an optical axis.

### BACKGROUND OF THE INVENTION

### Field of the Invention

The present invention relates to a lens assembly.

### Description of the Related Art

The current development trend of a lens assembly is toward large stop and high resolution. Additionally, the lens assembly is developed to have miniaturization in accordance with different application requirements. However, the known lens assembly can't satisfy such requirements. Therefore, the lens assembly needs a new structure in order to meet the requirements of large stop, high resolution, and miniaturization at the same time.

### BRIEF SUMMARY OF THE INVENTION

The invention provides a lens assembly to solve the above problems. The lens assembly of the invention is provided with characteristics of a decreased F-number, an increased resolution, a decreased total lens length, and still has a good optical performance.

The lens assembly in accordance with an exemplary embodiment of the invention includes a first lens, a second lens, and a third lens. The first lens is a meniscus lens with positive refractive power and includes a convex surface facing an object side and a concave surface facing an image side. The second lens is with positive refractive power and includes a convex surface facing the image side. The third lens is with refractive power and includes a concave surface facing the image side. The first lens, the second lens, and the third lens are arranged in order from the object side to the image side along an optical axis. The lens assembly satisfies the following conditions: 0.4 mm⁻²≤1/(f×f1)≤0.6 mm⁻²; 12≤(f1/CT1)+(f2/CT2)≤30; wherein f is an effective focal length of the lens assembly, f1 is an effective focal length of the first lens, f2 is an effective focal length of the second lens, CT1 is an interval from an object side surface of the first lens to an image side surface of the first lens along the optical axis, and CT2 is an interval from an object side surface of the second lens to an image side surface of the second lens along the optical axis.

The lens assembly in accordance with another exemplary embodiment of the invention includes a first lens, a second lens, and a third lens. The first lens is with positive refractive power and includes a convex surface facing an object side. The second lens is with positive refractive power and includes a convex surface facing an image side. The third lens is with refractive power and includes a concave surface facing the image side. The first lens, the second lens, and the third lens are arranged in order from the object side to the image side along an optical axis. The lens assembly satisfies the following conditions: 0.4 mm⁻²≤1/(f×f1)≤0.6 mm⁻²; 9≤R12/CT1≤17; 12≤(f1/CT1)+(f2/CT2)≤30; wherein f is an effective focal length of the lens assembly, f1 is an effective focal length of the first lens, f2 is an effective focal length of the second lens, CT1 is an interval from an object side surface of the first lens to an image side surface of the first lens along the optical axis, CT2 is an interval from an object side surface of the second lens to an image side surface of the second lens along the optical axis, and R12 is a radius of curvature of the image side surface of the first lens.

The lens assembly in accordance with yet another exemplary embodiment of the invention includes a first lens, a second lens, and a third lens. The first lens is with positive refractive power and includes a convex surface facing an object side. The second lens is with positive refractive power and includes a convex surface facing an image side. The third lens is with refractive power and includes a concave surface facing the image side. The first lens, the second lens, and the third lens are arranged in order from the object side to the image side along an optical axis. The lens assembly satisfies at least one of the following conditions: 1.2<f/\sqrt{R11}<1.5; 1.7 mm²<f×TTL<2.8 mm²; 1.2 mm<(f×f2)/TTL<3.5 mm; 4<R12/BFL<5; 10 mm<(f2×f2)/(TTL/2)<24 mm; wherein f is an effective focal length of the lens assembly, f2 is an effective focal length of the second lens, TTL is an interval from an object side surface of the first lens to an image plane along the optical axis, BFL is an interval from an image side surface of the third lens to the image plane along the optical axis, R11 is a radius of curvature of the object side surface of the first lens, and R12 is a radius of curvature of an image side surface of the first lens.

In another exemplary embodiment, the second lens is a meniscus lens and further includes a concave surface facing the object side.

In yet another exemplary embodiment, the third lens is a meniscus lens and further includes a convex surface facing the object side.

In another exemplary embodiment, the third lens is with positive refractive power.

In yet another exemplary embodiment, the third lens is with negative refractive power.

In another exemplary embodiment, the lens assembly further includes a stop disposed between the object side and the first lens, wherein the first lens, the second lens, and the third lens are aspheric lenses and made of plastic material. In yet another exemplary embodiment, the lens assembly satisfies at least one of the following conditions: 9≤R12/CT1≤17; −4≤(R21+R22) /CT2≤−2.5; 7 mm≤|f3/(Vd2/Vd3)|≤23 mm; 0.01≤|CT3/f3|≤0.05; 6≤(f1+f2)/(CT1+CT2)≤13; 1.2≤f/(CT1+CT2+CT3)≤1.9; 6 mm≤|R31−(f1+f3)|≤22 mm; 3≤(TTL+f)/R11≤4.5; wherein f is the effective focal length of the lens assembly, f1 is the effective focal length of the first lens, f2 is the effective focal length of the second lens, f3 is an effective focal length of the third lens, R11 is a radius of curvature of the object side surface of the first lens, R12 is a radius of curvature of the image side surface of the first lens, R21 is a radius of curvature of the object side surface of the second lens, R22 is a radius of curvature of the image side surface of the second lens, R31 is the radius of curvature of an object side surface of the third lens, TTL is an interval from the object side surface of the first lens to an image plane along the optical axis, Vd2 is an Abbe number of the second lens, Vd3 is an Abbe number of the third lens, CT1 is the interval from the object side surface of the first lens to the image side surface of the first lens along the optical axis, CT2 is the interval from the object side surface of the second lens to the image side surface of the second lens along the optical axis, and CT3 is an interval from an object side surface of the third lens to an image side surface of the third lens along the optical axis.

In another exemplary embodiment, the first lens is a meniscus lens and further includes a concave surface facing the image side and the second lens is a meniscus lens and further includes a concave surface facing the object side.

In yet another exemplary embodiment, the lens assembly satisfies at least one of the following conditions: −4≤(R21+R22)/CT2≤−2.5; 7 mm≤|f3/(Vd2/Vd3)|≤23 mm; 0.01≤|CT3/f3|≤0.05; 6≤(f1+f2)/(CT1+CT2)≤13; 1.2≤f/(CT1+CT2+CT3)≤1.9; 6 mm≤|R31−(f1+f3)|≤22 mm; 3≤(TTL+f)/R11≤4.5; wherein f is the effective focal length of the lens assembly, f1 is the effective focal length of the first lens, f2 is the effective focal length of the second lens, f3 is an effective focal length of the third lens, R11 is a radius of curvature of the object side surface of the first lens, R21 is a radius of curvature of the object side surface of the second lens, R22 is a radius of curvature of the image side surface of the second lens, R31 is the radius of curvature of an object side surface of the third lens, TTL is an interval from the object side surface of the first lens to an image plane along the optical axis, Vd2 is an Abbe number of the second lens, Vd3 is an Abbe number of the third lens, CT1 is the interval from the object side surface of the first lens to the image side surface of the first lens along the optical axis, CT2 is the interval from the object side surface of the second lens to the image side surface of the second lens along the optical axis, and CT3 is an interval from an object side surface of the third lens to an image side surface of the third lens along the optical axis.

In another exemplary embodiment, the lens assembly satisfies at least one of the following conditions: 0.4 mm⁻²≤1/(f×f1)≤0.6 mm⁻²; 9≤R12/CT1≤17; −4≤(R21+R22)/CT2≤−2.5; 7 mm≤|f3/(Vd2/Vd3)|≤23 mm; 0.01≤|CT3/f3|≤0.05; 12≤(f1/CT1)+(f2/CT2)≤30; 6≤(f1+f2)/(CT1+CT2)≤13; 1.2≤f/(CT1+CT2+CT3)≤1.9; 6 mm≤|R31−(f1+f3)|≤22 mm; 3≤(TTL+f)/R11≤4.5; wherein f is the effective focal length of the lens assembly, f1 is the effective focal length of the first lens, f2 is the effective focal length of the second lens, f3 is an effective focal length of the third lens, R11 is a radius of curvature of the object side surface of the first lens, R12 is a radius of curvature of the image side surface of the first lens, R21 is a radius of curvature of the object side surface of the second lens, R22 is a radius of curvature of the image side surface of the second lens, R31 is the radius of curvature of an object side surface of the third lens, TTL is an interval from the object side surface of the first lens to an image plane along the optical axis, Vd2 is an Abbe number of the second lens, Vd3 is an Abbe number of the third lens, CT1 is the interval from the object side surface of the first lens to the image side surface of the first lens along the optical axis, CT2 is the interval from the object side surface of the second lens to the image side surface of the second lens along the optical axis, and CT3 is an interval from an object side surface of the third lens to an image side surface of the third lens along the optical axis.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a lens assembly in accordance with a first embodiment of the invention;

FIG. 2 depicts a longitudinal aberration diagram of the lens assembly in accordance with the first embodiment of the invention;

FIG. 3 depicts a field curvature diagram of the lens assembly in accordance with the first embodiment of the invention;

FIG. 4 depicts a distortion diagram of the lens assembly in accordance with the first embodiment of the invention;

FIG. 5 is a lens layout and optical path diagram of a lens assembly in accordance with a second embodiment of the invention;

FIG. 6 depicts a longitudinal aberration diagram of the lens assembly in accordance with the second embodiment of the invention;

FIG. 7 depicts a field curvature diagram of the lens assembly in accordance with the second embodiment of the invention;

FIG. 8 depicts a distortion diagram of the lens assembly in accordance with the second embodiment of the invention;

FIG. 9 is a lens layout and optical path diagram of a lens assembly in accordance with a third embodiment of the invention;

FIG. 10 is a lens layout and optical path diagram of a lens assembly in accordance with a fourth embodiment of the invention; and

FIG. 11 is a lens layout and optical path diagram of a lens assembly in accordance with a fifth embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens assembly including a first lens, a second lens, and a third lens. The first lens is a meniscus lens with positive refractive power and includes a convex surface facing an object side and a concave surface facing an image side. The second lens is with positive refractive power and includes a convex surface facing the image side. The third lens is with refractive power and includes a concave surface facing the image side. The first lens, the second lens, and the third lens are arranged in order from the object side to the image side along an optical axis. The lens assembly satisfies the following conditions: 0.4 mm⁻²≤1/(f×f1)≤0.6 mm⁻²; 12≤(f1/CT1)+(f2/CT2)≤30; wherein f is an effective focal length of the lens assembly, f1 is an effective focal length of the first lens, f2 is an effective focal length of the second lens, CT1 is an interval from an object side surface of the first lens to an image side surface of the first lens along the optical axis, and CT2 is an interval from an object side surface of the second lens to an image side surface of the second lens along the optical axis. A lens assembly of the present invention can achieve basic operation when the lens assembly satisfies the above features and at least one of the above conditions, and does not need other additional features and conditions.

The present invention provides another lens assembly including a first lens, a second lens, and a third lens. The first lens is with positive refractive power and includes a convex surface facing an object side. The second lens is with positive refractive power and includes a convex surface facing an image side. The third lens is with refractive power and includes a concave surface facing the image side. The first lens, the second lens, and the third lens are arranged in order from the object side to the image side along an optical axis. The lens assembly satisfies the following conditions: 0.4 mm⁻²≤1/(f×f1)≤0.6 mm⁻²; 9≤R12/CT1≤17; 12≤(f1/CT1)+(f2/CT2)≤30; wherein f is an effective focal length of the lens assembly, f1 is an effective focal length of the first lens, f2 is an effective focal length of the second lens, CT1 is an interval from an object side surface of the first lens to an image side surface of the first lens along the optical axis, CT2 is an interval from an object side surface of the second lens to an image side surface of the second lens along the optical axis, and R12 is a radius of curvature of the image side surface of the first lens. A lens assembly of the present invention can achieve basic operation when the lens assembly satisfies the above features and at least one of the above conditions, and does not need other additional features and conditions.

The present invention provides yet another lens assembly including a first lens, a second lens, and a third lens. The first lens is with positive refractive power and includes a convex surface facing an object side. The second lens is with positive refractive power and includes a convex surface facing an image side. The third lens is with refractive power and includes a concave surface facing the image side. The first lens, the second lens, and the third lens are arranged in order from the object side to the image side along an optical axis. The lens assembly satisfies at least one of the following conditions: 1.2<f/\sqrt{R11}<1.5; 1.7 mm²<f×TTL<2.8 mm²; 1.2 mm<(f×f2)/TTL<3.5 mm; 4<R12/BFL<5; 10 mm<(f2×f2)/(TTL/2)<24 mm; wherein f is an effective focal length of the lens assembly, f2 is an effective focal length of the second lens, TTL is an interval from an object side surface of the first lens to an image plane along the optical axis, BFL is an interval from an image side surface of the third lens to the image plane along the optical axis, R11 is a radius of curvature of the object side surface of the first lens, and R12 is a radius of curvature of an image side surface of the first lens. A lens assembly of the present invention can achieve basic operation when the lens assembly satisfies the above features and at least one of the above conditions, and does not need other additional features and conditions.

Referring to Table 1, Table 2, Table 4, Table 5, Table 7, Table 8, Table 10, Table 11, Table 13, and Table 14, wherein Table 1, Table 4, Table 7, Table 10, and Table 13 show optical specification in accordance with a first, second, third, fourth, and fifth embodiments of the invention, respectively, and Table 2, Table 5, Table 8, Table 11, and Table 14 show aspheric coefficients of each aspheric lens in Table 1, Table 4, Table 7, Table 10, and Table 13, respectively.

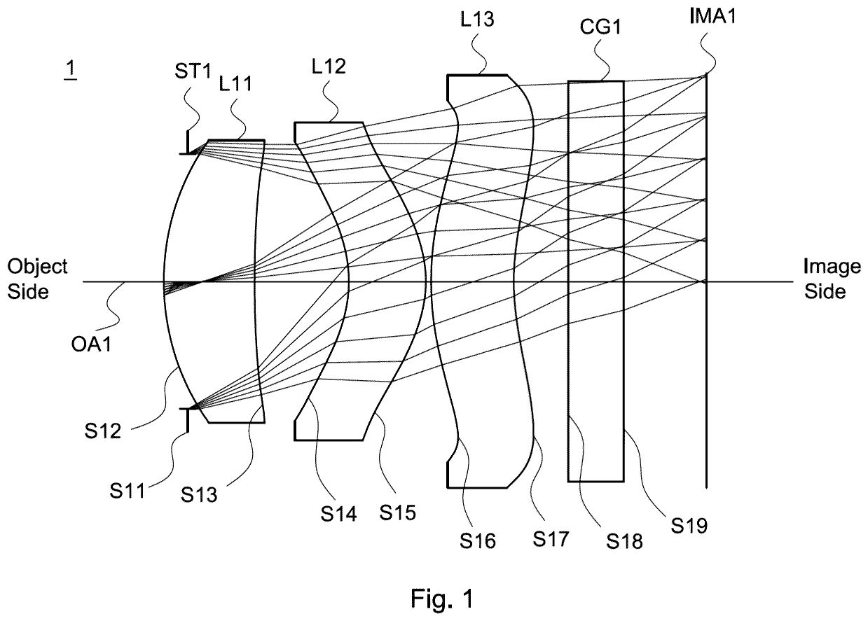

FIGS. 1, 5, 9, 10, 11 are lens layout and optical path diagrams of the lens assemblies in accordance with the first, second, third, fourth, and fifth embodiments of the invention, respectively.

The first lenses L11, L21, L31, L41, L51 are meniscus lenses with positive refractive power and made of plastic material, wherein the object side surfaces S12, S22, S32, S42, S52 are convex surfaces, the image side surfaces S13, S23, S33, S43, S53 are concave surfaces, and both of the object side surfaces S12, S22, S32, S42, S52 and image side surfaces S13, S23, S33, S43, S53 are aspheric surfaces.

The second lenses L12, L22, L32, L42, L52 are meniscus lens with positive refractive power and made of plastic material, wherein the object side surfaces S14, S24, S34, S44, S54 are concave surfaces, the image side surfaces S15, S25, S35, S45, S55 are convex surfaces, and both of the object side surfaces S14, S24, S34, S44, S54 and image side surfaces S15, S25, S35, S45, S55 are aspheric surfaces.

The third lenses L13, L23, L33, L43, L53 are meniscus lens and made of plastic material, wherein the object side surfaces S16, S26, S36, S46, S56 are convex surfaces, the image side surfaces S17, S27, S37, S47, S57 are concave surfaces, and both of the object side surfaces S16, S26, S36, S46, S56 and image side surfaces S17, S27, S37, S47, S57 are aspheric surfaces.

In addition, the lens assemblies 1 and 4 satisfy at least one of the following conditions (1)-(13), the lens assembly 2 satisfies at least one of the following conditions (1)-(14), the lens assembly 3 satisfies at least one of the following conditions (1)-(15), and the lens assembly 5 satisfies at least one of the following conditions (2)-(15):

$$0.4 {mm}^{- 2} \leq 1 / ( f \times f 1 ) \leq 0.6 {mm}^{- 2} ; \qquad ( 1 )$$

$$9 \leq R 12 / CT 1 \leq 17 ; \qquad ( 2 )$$

$$6 mm \leq \vert R 31 - ( f 1 + f3 ) \vert \leq 22 mm ; \qquad ( 3 )$$

$$- 4 \leq ( R 21 + R 22 ) / CT 2 \leq - 2.5 ; \qquad ( 4 )$$

$$7 mm \leq \vert f 3 / ( Vd 2 / Vd 3 ) \vert \leq 23 mm ; \qquad ( 5 )$$

$$0.01 \leq \vert CT 3 / f 3 \vert \leq 0.05 ; \qquad ( 6 )$$

$$12 \leq ( f 1 / CT 1 ) + ( f 2 / CT 2 ) \leq 30 ; \qquad ( 7 )$$

$$6 \leq ( f 1 + f 2 ) / ( CT 1 + CT 2 ) \leq 13 ; \qquad ( 8 )$$

$$3 \leq ( TTL + f ) / R 11 \leq 4.5 ; \qquad ( 9 )$$

$$1.2 \leq f / ( CT 1 + CT 2 + CT 3 ) \leq 1.9 ; \qquad ( 10 )$$

$$1.2 < f / \sqrt{R 11} < 1.5 ; \qquad ( 11 )$$

$$1.7 {mm}^{2} < f \times TTL < 2.8 {mm}^{2} ; \qquad ( 12 )$$

$$1.2 mm < ( f \times f 2 ) / TTL < 3.5 mm ; \qquad ( 13 )$$

$$4 < R 12 / BFL < 5 ; \qquad ( 14 )$$

$$10 mm < ( f 2 \times f 2 ) / ( TTL / 2 ) < 24 mm ; \qquad ( 15 )$$

wherein: f is an effective focal length of the lens assemblies 1, 2, 3, 4, 5 for the first to fifth embodiments; f1 is an effective focal length of the first lenses L11, L21, L31, L41, L51 for the first to fifth embodiments; f2 is an effective focal length of the second lenses L12, L22, L32, L42, L52 for the first to fifth embodiments; f3 is an effective focal length of the third lenses L13, L23, L33, L43, L53 for the first to fifth embodiments; R11 is a radius of curvature of the object side surfaces S12, S22, S32, S42, S52 of the first lenses L11, L21, L31, L41, L51 for the first to fifth embodiments; R12 is a radius of curvature of the image side surfaces S13, S23, S33, S43, S53 of the first lenses L11, L21, L31, L41, L51 for the first to fifth embodiments; R21 is a radius of curvature of the object side surfaces S14, S24, S34, S44, S54 of the second lenses L12, L22, L32, L42, L52 for the first to fifth embodiments; R22 is a radius of curvature of the image side surfaces S15, S25, S35, S45, S55 of the second lenses L12, L22, L32, L42, L52 for the first to fifth embodiments; R31 is a radius of curvature of the object side surfaces S16, S26, S36, S46, S56 of the third lenses L13, L23, L33, L43, L53 for the first to fifth embodiments; TTL is an interval from the object side surfaces S12, S22, S32, S42, S52 of the first lenses L11, L21, L31, L41, L51 to the image planes IMA1, IMA2, IMA3, IMA4, IMA5 along the optical axes OA1, OA2, OA3, OA4, OA5 for the first to fifth embodiments; Vd2 is an Abbe number of the second lenses L12, L22, L32, L42, L52 for the first to fifth embodiments; Vd3 is an Abbe number of the third lenses L13, L23, L33, L43, L53 for the first to fifth embodiments; CT1 is an interval from the object side surfaces S12, S22, S32, S42, S52 of the first lenses L11, L21, L31, L41, L51 to the image side surfaces S13, S23, S33, S43, S53 of the first lenses L11, L21, L31, L41, L51 along the optical axes OA1, OA2, OA3, OA4, OA5 for the first to fifth embodiments; CT2 is an interval from the object side surfaces S14, S24, S34, S44, S54 of the second lenses L12, L22, L32, L42, L52 to the image side surfaces S15, S25, S35, S45, S55 of the second lenses L12, L22, L32, L42, L52 along the optical axes OA1, OA2, OA3, OA4, OA5 for the first to fifth embodiments; CT3 is an interval from the object side surfaces S16, S26, S36, S46, S56 of the third lenses L13, L23, L33, L43, L53 to the image side surfaces S17, S27, S37, S47, S57 of the third lenses L13, L23, L33, L43, L53 along the optical axes OA1, OA2, OA3, OA4, OA5 for the first to fifth embodiments; and BFL is an interval from the image side surfaces S17, S27, S37, S47, S57 of the third lenses L13, L23, L33, L43, L53 to the image planes IMA1, IMA2, IMA3, IMA4, IMA5 along the optical axes OA1, OA2, OA3, OA4, OA5 for the first to fifth embodiments. Making lens assemblies 1, 2, 3, 4, and 5 having reduced F-number, shortened total lens length, and corrected aberration. A lens assembly of the present invention is a preferred embodiment of the present invention when the lens assembly satisfies the above features and at least one of the above conditions.

When the condition (1): 0.4 mm⁻²≤1/(f×f1)≤0.6 mm⁻² is satisfied, the effective focal length and total lens length of the lens assembly can be decreased effectively. When the conditions (2), (3), (4): 9≤R12/CT1≤17, 6 mm≤|R31−(f1+f3)|≤22 mm, −4≤(R21+R22)/CT2≤−2.5 are satisfied, the aberration can be corrected effectively by controlling the radius of curvature of the first, second, and third lenses and the thickness of the first and second lenses. When the condition (5): 7 mm≤|f3/(Vd2/Vd3)|≤23 mm is satisfied, the chromatic aberration can be corrected effectively and resolution can be increased effectively. When the condition (6): 0.01≤|CT3/f3|≤0.05 is satisfied, the aberration can be corrected effectively and resolution can be increased effectively. When the condition (7): 12≤(f1/CT1)+(f2/CT2)≤30 is satisfied, helping the first lens and the second lens matching up to effectively reduce the volume of the lens assembly. When the condition (8): 6≤(f1+f2)/(CT1+CT2)≤13 is satisfied, helping the first lens and the second lens matching up with each other to effectively reduce the volume of the lens assembly. When the condition (9): 3≤(TTL+f)/R11≤4.5 is satisfied, conducive to the setting of the first lens and effectively correct aberration. When the condition (10): 1.2≤f/(CT1+CT2+CT3)≤1.9 is satisfied, the space can be effectively used and the volume of the lens assembly can be effectively decreased.

A detailed description of a lens assembly in accordance with a first embodiment of the invention is as follows. Referring to FIG. 1, the lens assembly 1 includes a stop ST1, a first lens L11, a second lens L12, a third lens L13, and a cover glass CG1, all of which are arranged in order from an object side to an image side along an optical axis OA1. In operation, the light from the object side is imaged on an image plane IMA1. According to the foregoing, wherein: the third lens L13 is with negative refractive power; both of the object side surface S18 and image side surface S19 of the cover glass CG1 are plane surfaces; and with the above design of the lenses, stop ST1, and at least one of the conditions (1)-(13) satisfied, the lens assembly 1 can have an effective decreased f-number, an effective decreased total lens length, and an effective corrected aberration.

Table 1 shows the optical specification of the lens assembly 1 in FIG. 1.

TABLE 1
Effective Focal Length = 1.346 mm F-number = 1.4
Total Lens Length = 2.044 mm Field of View = 60 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S11 | ∞ | −0.090 | | | | ST1 |
| S12 | 0.945 | 0.342 | 1.671 | 19.243 | 1.791 | L11 |
| S13 | 4.516 | 0.355 | | | | |
| S14 | −0.510 | 0.290 | 1.671 | 19.243 | 2.034 | L12 |
| S15 | −0.449 | 0.020 | | | | |
| S16 | 1.272 | 0.312 | 1.661 | 20.382 | −7.028 | L13 |
| S17 | 0.895 | 0.205 | | | | |
| S18 | ∞ | 0.210 | 1.517 | 64.167 | | CG1 |
| S19 | ∞ | 0.310 | | | | |

The aspheric surface sag z of each lens in table 1 can be calculated by the following formula:

$$z = {ch}^{2} / \{ 1 + {[ 1 - ( k + 1 ) {c}^{2} {h}^{2} ]}^{1 / 2} \} + {Ah}^{4} + {Bh}^{6} + {Ch}^{8} + {Dh}^{l 0} + {Eh}^{12} + {Fh}^{14} + {Gh}^{16}$$

where c is curvature, h is the vertical distance from the lens surface to the optical axis, k is conic constant and A, B, C, D, E, F and G are aspheric coefficients.

In the first embodiment, the conic constant k and the aspheric coefficients A, B, C, D, E, F, G of each aspheric lens are shown in Table 2.

TABLE 2

| Surface | | A | B | C | |
|---|---|---|---|---|---|
| Number | k | E | F | G | D |
| S12 | 1.281152 | −0.035465 | −1.676842 | 6.626849 | −15.741248 |
| | | 0 | 0 | 0 | |
| S13 | 0 | 0.153291 | −1.759521 | 16.570931 | −40.105367 |
| | | 0 | 0 | 0 | |
| S14 | −0.205828 | 1.459685 | 0.977181 | 15.368269 | −23.300601 |
| | | 0 | 0 | 0 | |
| S15 | −5.610247 | −2.417078 | 10.009736 | −12.950512 | 3.965500 |
| | | 0 | 0 | 0 | |
| S16 | −1.332915 | 1.541404 | −28.668759 | 239.601992 | −1155.467655 |
| | | 3186.083422 | −4673.075451 | 2794.187444 | |
| S17 | 0.216861 | −2.409363 | 8.622663 | −27.085587 | 46.767364 |
| | | −41.954364 | 4.932322 | 9.459968 | |

Table 3 shows the parameters and condition values for conditions (1)-(13) in accordance with the first embodiment of the invention. It can be seen from Table 3 that the lens assembly 1 of the first embodiment satisfies the conditions (1)-(13).

TABLE 3

| 1/(f × f1) | 0.42 | mm⁻² | R12/CT1 | 13.20 |
|---|---|---|---|---|
| \|R31 − (f1 + f3)\| | 6.51 | mm | (R21 + R22)/CT2 | −3.31 |
| \|f3/(Vd2/Vd3)\| | 7.44 | mm | \|CT3/f3\| | 0.04 |
| (f1/CT1) + (f2/CT2) | 12.25 | | (f1 + f2)/(CT1 + CT2) | 6.05 |
| (TTL + f)/R11 | 3.59 | | f/(CT1 + CT2 + CT3) | 1.43 |
| f/\sqrt{R11} | 1.38 | | f × TTL | 2.75 mm² |
| (f × f2)/TTL | 1.34 | mm | | |

The lens assembly 1 can meet the basic operation requirements when it is modified to only satisfies at least one of the conditions (1)-(13), the first lens having positive refractive power and a convex surface facing the object side, the second lens having positive refractive power and a convex surface facing the image isde, the third lens having a concave surface facing the image side, and does not need other additional features and conditions.

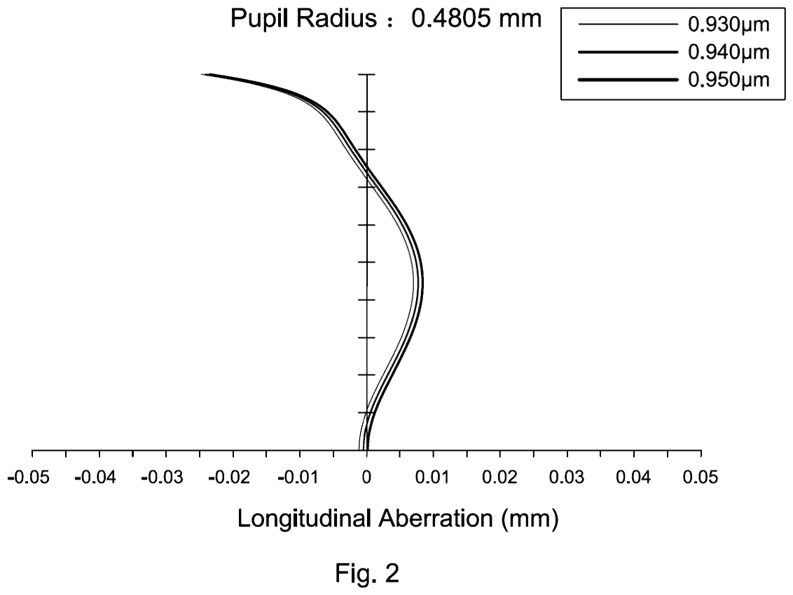

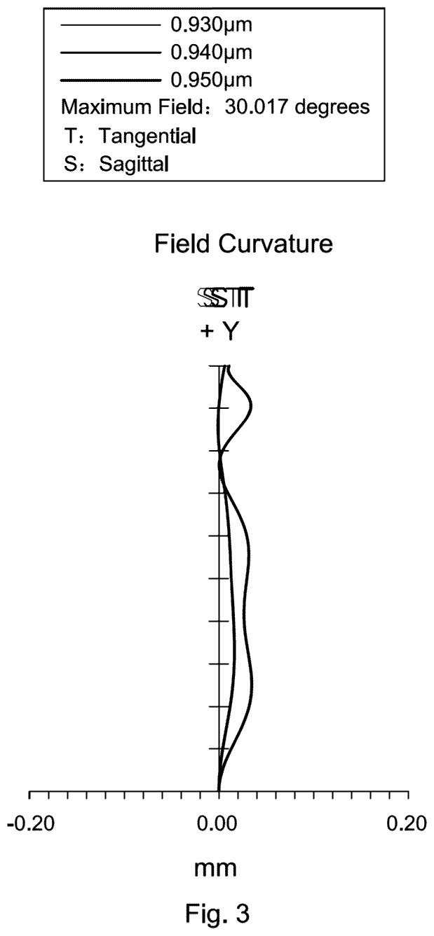

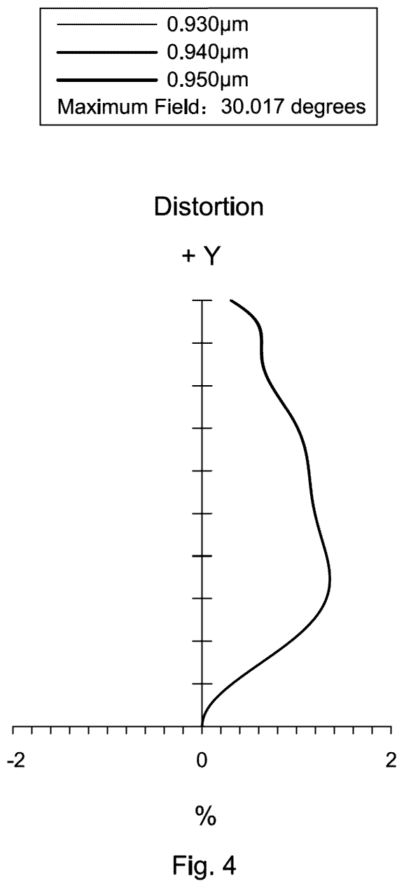

In addition, the lens assembly 1 of the first embodiment can meet the requirements of optical performance as seen in FIGS. 2-4. It can be seen from FIG. 2 that the longitudinal aberration in the lens assembly 1 of the first embodiment ranges from −0.025 mm to 0.01 mm. It can be seen from FIG. 3 that the field curvature of tangential direction and sagittal direction in the lens assembly 1 of the first embodiment ranges from 0.0 mm to 0.04 mm. It can be seen from FIG. 4 that the distortion in the lens assembly 1 of the first embodiment ranges from 0% to 1.7%. It is obvious that the longitudinal aberration, the field curvature, and the distortion of the lens assembly 1 of the first embodiment can be corrected effectively. Therefore, the lens assembly 1 of the first embodiment is capable of good optical performance. The lens assembly 1 satisfies conditions (1)-(13) as well as the refractive power and surface shape of Table 1 and Table 2, which is a preferred embodiment of the present invention.

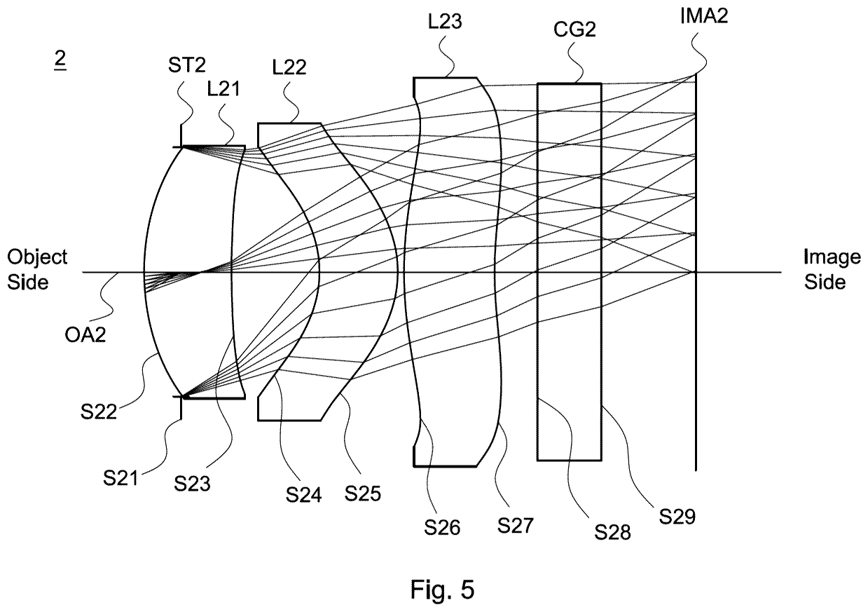

A detailed description of a lens assembly in accordance with a second embodiment of the invention is as follows. Referring to FIG. 5, the lens assembly 2 includes a stop ST2, a first lens L21, a second lens L22, a third lens L23, and a cover glass CG2, all of which are arranged in order from an object side to an image side along an optical axis OA2. In operation, the light from the object side is imaged on an image plane IMA2. According to the foregoing, wherein: the third lens L23 is with positive refractive power; both of the object side surface S28 and image side surface S29 of the cover glass CG2 are plane surfaces; and with the above design of the lenses, stop ST2, and at least one of the conditions (1)-(14) satisfied, the lens assembly 2 can have an effective decreased f-number, an effective decreased total lens length, and an effective corrected aberration.

Table 4 shows the optical specification of the lens assembly 2 in FIG. 5.

TABLE 4
Effective Focal Length = 1.145 mm F-number = 1.4
Total Lens Length = 1.814 mm Field of View = 59.6 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S21 | ∞ | −0.122 | | | | ST2 |
| S22 | 0.775 | 0.287 | 1.671 | 19.243 | 1.531 | L21 |
| S23 | 3.119 | 0.289 | | | | |
| S24 | −0.375 | 0.257 | 1.671 | 19.243 | 2.370 | L22 |
| S25 | −0.382 | 0.020 | | | | |
| S26 | 1.164 | 0.299 | 1.661 | 20.382 | 21.295 | L23 |
| S27 | 1.147 | 0.142 | | | | |
| S28 | ∞ | 0.210 | 1.517 | 64.167 | | CG2 |
| S29 | ∞ | 0.310 | | | | |

The definition of aspheric surface sag z of each aspheric lens in Table 4 is the same as that of in Table 1, and is not described here again.

In the second embodiment, the conic constant k and the aspheric coefficients A, B, C, D, E, F, G of each aspheric lens are shown in Table 5.

TABLE 5

| Surface | | A | B | C | |
|---|---|---|---|---|---|
| Number | k | E | F | G | D |
| S22 | 1.845237 | 0.138557 | −13.388405 | 113.282519 | −391.109904 |
| | | 0 | 0 | 0 | |
| S23 | 0 | 0.747833 | −13.691610 | 142.322400 | −369.936581 |
| | | 0 | 0 | 0 | |
| S24 | −0.331837 | 1.461000 | −5.392424 | 160.606015 | −257.989559 |
| | | 0 | 0 | 0 | |
| S25 | −1.412138 | −0.498211 | −1.549183 | 33.436007 | −52.171089 |
| | | 0 | 0 | 0 | |
| S26 | −20.739100 | −0.213536 | 0.084930 | 50.485982 | −645.166522 |
| | | 3400.243936 | −8704.383645 | 8640.799560 | |
| S27 | −43.664770 | −0.532986 | −9.260761 | 120.467085 | −728.883946 |
| | | 2377.419072 | −4085.858252 | 2876.263235 | |

Table 6 shows the parameters and condition values for conditions (1)-(14) in accordance with the second embodiment of the invention. It can be seen from Table 6 that the lens assembly 2 of the second embodiment satisfies the conditions (1)-(14).

TABLE 6

| 1/(f × f1) | 0.57 | mm⁻² | R12/CT1 | 10.87 |
|---|---|---|---|---|
| \|R31 − (f1 + f3)\| | 21.66 | mm | (R21 + R22)/CT2 | −2.95 |
| \|f3/(Vd2/Vd3)\| | 22.56 | mm | \|CT3/f3\| | 0.01 |
| (f1/CT1) + (f2/CT2) | 14.56 | | (f1 + f2)/(CT1 + CT2) | 7.17 |
| (TTL + f)/R11 | 3.82 | | f/(CT1 + CT2 + CT3) | 1.36 |
| f/\sqrt{R11} | 1.30 | | f × TTL | 2.08 mm² |
| (f × f2)/TTL | 1.50 | mm | R12/BFL | 4.7 |

The lens assembly 2 can meet the basic operation requirements when it is modified to only satisfies at least one of the conditions (1)-(14), the first lens having positive refractive power and a convex surface facing the object side, the second lens having positive refractive power and a convex surface facing the image isde, the third lens having a concave surface facing the image side, and does not need other additional features and conditions.

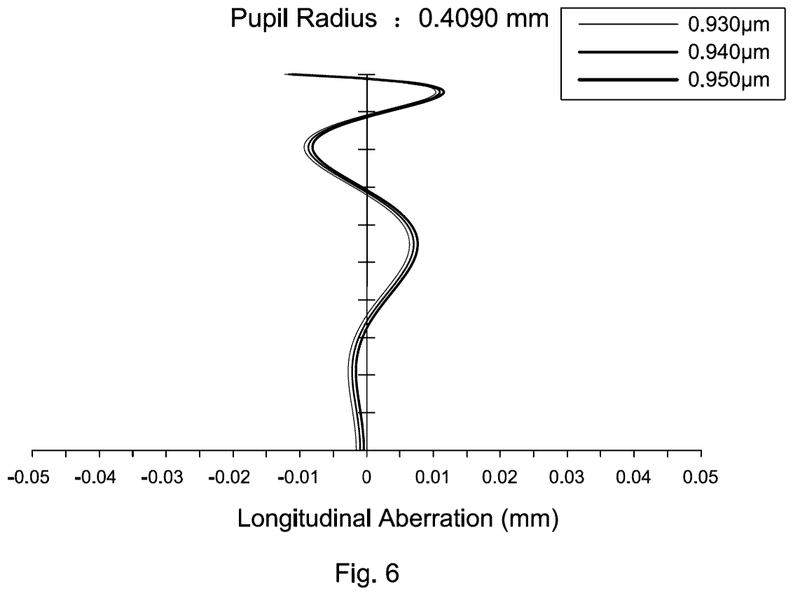

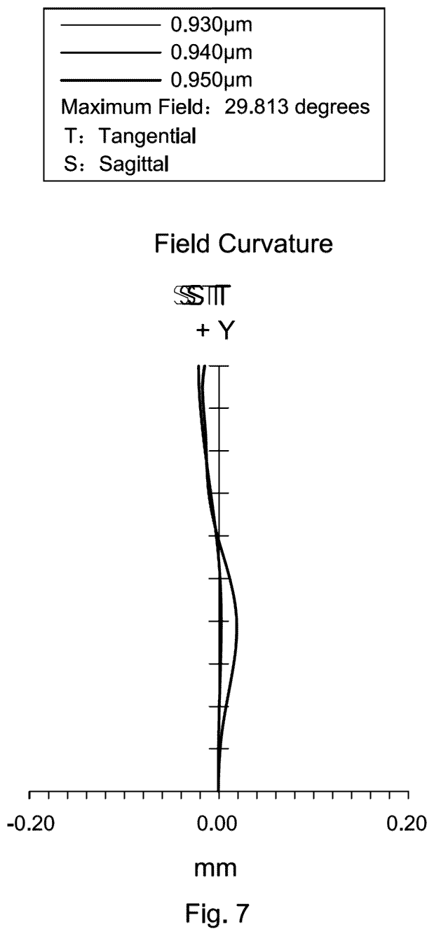

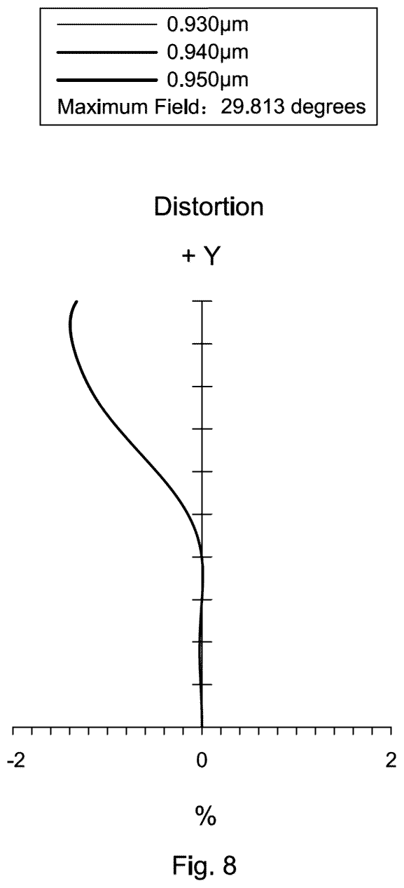

In addition, the lens assembly 2 of the second embodiment can meet the requirements of optical performance as seen in FIGS. 6-8. It can be seen from FIG. 6 that the longitudinal aberration in the lens assembly 2 of the second embodiment ranges from −0.015 mm to 0.015 mm. It can be seen from FIG. 7 that the field curvature of tangential direction and sagittal direction in the lens assembly 2 of the second embodiment ranges from −0.04 mm to 0.04 mm. It can be seen from FIG. 8 that the distortion in the lens assembly 2 of the second embodiment ranges from −1.7% to 0%. It is obvious that the longitudinal aberration, the field curvature, and the distortion of the lens assembly 2 of the second embodiment can be corrected effectively. Therefore, the lens assembly 2 of the second embodiment is capable of good optical performance. The lens assembly 2 satisfies conditions (1)-(14) as well as the refractive power and surface shape of Table 4 and Table 5, which is a preferred embodiment of the present invention.

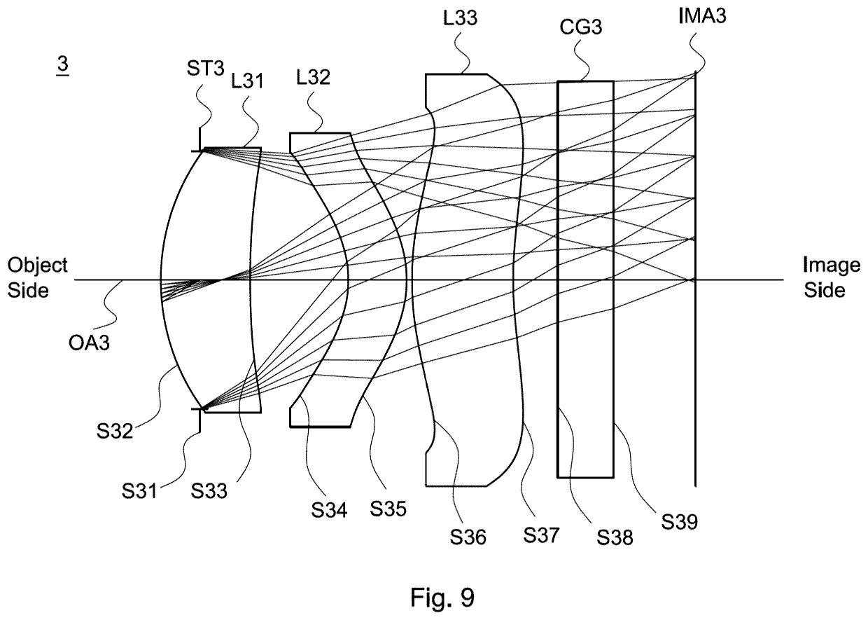

A detailed description of a lens assembly in accordance with a third embodiment of the invention is as follows. Referring to FIG. 9, the lens assembly 3 includes a stop ST3, a first lens L31, a second lens L32, a third lens L33, and a cover glass CG3, all of which are arranged in order from an object side to an image side along an optical axis OA3. In operation, the light from the object side is imaged on an image plane IMA3. According to the foregoing, wherein: the third lens L33 is with positive refractive power; both of the object side surface S38 and image side surface S39 of the cover glass CG3 are plane surfaces; and with the above design of the lenses, stop ST3, and at least one of the conditions (1)-(15) satisfied, the lens assembly 3 can have an effective decreased f-number, an effective decreased total lens length, and an effective corrected aberration.

Table 7 shows the optical specification of the lens assembly 3 in FIG. 9.

TABLE 7
Effective Focal Length = 1.358 mm F-number = 1.4
Total Lens Length = 2.017 mm Field of View = 59.6 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S31 | ∞ | −0.147 | | | | ST3 |
| S32 | 0.856 | 0.336 | 1.671 | 19.243 | 1.737 | L31 |
| S33 | 3.099 | 0.370 | | | | |
| S34 | −0.418 | 0.220 | 1.671 | 19.243 | 4.731 | L32 |
| S35 | −0.443 | 0.020 | | | | |
| S36 | 1.251 | 0.383 | 1.661 | 20.382 | 8.820 | L33 |
| S37 | 1.420 | 0.168 | | | | |
| S38 | ∞ | 0.210 | 1.517 | 64.167 | | CG3 |
| S39 | ∞ | 0.310 | | | | |

The definition of aspheric surface sag z of each aspheric lens in Table 7 is the same as that of in Table 1, and is not described here again.

In the third embodiment, the conic constant k and the aspheric coefficients A, B, C, D, E, F, G of each aspheric lens are shown in Table 8.

TABLE 8

| Surface | | A | B | C | |
|---|---|---|---|---|---|
| Number | k | E | F | G | D |
| S32 | 1.150141 | 0.047589 | −3.319568 | 15.988799 | −38.476031 |
| | | 0 | 0 | 0 | |
| S33 | 0 | 0.319261 | −4.329555 | 32.431321 | −80.415112 |
| | | 0 | 0 | 0 | |
| S34 | −0.398306 | 2.201196 | −1.922895 | 44.336325 | −86.730476 |
| | | 0 | 0 | 0 | |
| S35 | −5.393435 | −3.050034 | 14.160307 | −18.527074 | 3.971082 |
| | | 0 | 0 | 0 | |
| S36 | 0.686405 | 0.844847 | −24.523196 | 225.538061 | −1172.702835 |
| | | 3448.850085 | −5356.467646 | 3363.964749 | |
| S37 | 2.160387 | −1.507532 | 4.159343 | −11.522748 | 17.035575 |
| | | −18.409756 | 14.426503 | −10.067043 | |

Table 9 shows the parameters and condition values for conditions (1)-(15) in accordance with the third embodiment of the invention. It can be seen from Table 9 that the lens assembly 3 of the third embodiment satisfies the conditions (1)-(15).

TABLE 9

| 1/(f × f1) | 0.42 | mm⁻² | R12/CT1 | 9.22 |
|---|---|---|---|---|
| \|R31 − (f1 + f3)\| | 9.31 | mm | (R21 + R22)/CT2 | −3.91 |
| \|f3/(Vd2/Vd3)\| | 9.34 | mm | \|CT3/f3\| | 0.04 |
| (f1/CT1) + (f2/CT2) | 26.67 | | (f1 + f2)/(CT1 + CT2) | 11.63 |
| (TTL + f)/R11 | 3.94 | | f/(CT1 + CT2 + CT3) | 1.45 |
| f/\sqrt{R11} | 1.47 | | f × TTL | 2.74 mm² |
| (f × f2)/TTL | 3.19 | mm | R12/BFL | 4.50 |
| (f2×f2)/(TTL/2) | 22.19 | mm | | |

The lens assembly 3 can meet the basic operation requirements when it is modified to only satisfies at least one of the conditions (1)-(15), the first lens having positive refractive power and a convex surface facing the object side, the second lens having positive refractive power and a convex surface facing the image isde, the third lens having a concave surface facing the image side, and does not need other additional features and conditions.

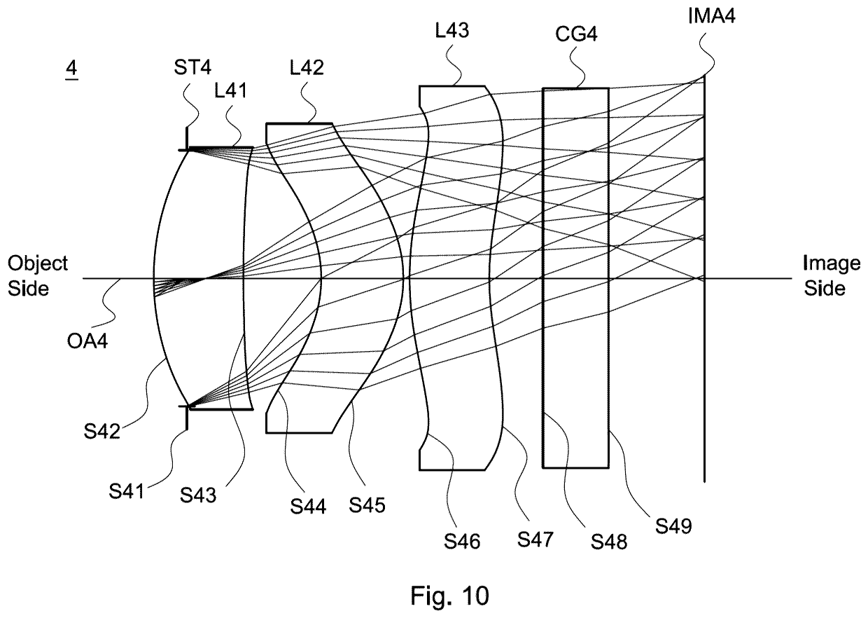

A detailed description of a lens assembly in accordance with a fourth embodiment of the invention is as follows. Referring to FIG. 10, the lens assembly 4 includes a stop ST4, a first lens L41, a second lens L42, a third lens L43, and a cover glass CG4, all of which are arranged in order from an object side to an image side along an optical axis OA4. In operation, the light from the object side is imaged on an image plane IMA4. According to the foregoing, wherein: the third lens L43 is with negative refractive power; both of the object side surface S48 and image side surface S49 of the cover glass CG4 are plane surfaces; and with the above design of the lenses, stop ST4, and at least one of the conditions (1)-(13) satisfied, the lens assembly 4 can have an effective decreased f-number, an effective decreased total lens length, and an effective corrected aberration.

Table 10 shows the optical specification of the lens assembly 4 in FIG. 10.

TABLE 10
Effective Focal Length = 1.153 mm F-number = 1.4
Total Lens Length = 1.778 mm Field of View = 59.6 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S41 | ∞ | −0.107 | | | | ST4 |
| S42 | 0.815 | 0.289 | 1.671 | 19.243 | 1.483 | L41 |
| S43 | 4.848 | 0.251 | | | | |
| S44 | −0.419 | 0.265 | 1.671 | 19.243 | 2.037 | L42 |
| S45 | −0.396 | 0.020 | | | | |
| S46 | 1.120 | 0.258 | 1.661 | 20.382 | −11.413 | L43 |
| S47 | 0.883 | 0.175 | | | | |
| S48 | ∞ | 0.210 | 1.517 | 64.167 | | CG4 |
| S49 | ∞ | 0.310 | | | | |

The definition of aspheric surface sag z of each aspheric lens in Table 10 is the same as that of in Table 1, and is not described here again.

In the fourth embodiment, the conic constant k and the aspheric coefficients A, B, C, D, E, F, G of each aspheric lens are shown in Table 11.

TABLE 11

| Surface | | A | B | C | |
|---|---|---|---|---|---|
| Number | k | E | F | G | D |
| S42 | 1.787204 | −0.351497 | −2.460111 | 13.031794 | −74.837004 |
| | | 0 | 0 | 0 | |
| S43 | 0 | 0.327332 | −5.702929 | 36.759441 | −17.837892 |
| | | 0 | 0 | 0 | |
| S44 | −0.363213 | 1.941576 | −8.019462 | 105.100479 | −149.720489 |
| | | 0 | 0 | 0 | |
| S45 | −4.481815 | −3.378642 | 11.684527 | −2.701829 | −15.247876 |
| | | 0 | 0 | 0 | |
| S46 | 0.775079 | 2.063965 | −76.899845 | 983.113183 | −7205.16355 |
| | | 30256.96737 | −67596.58985 | 61650.8020 | |
| S47 | 0.718199 | −2.918977 | −0.470076 | 114.933158 | −999.940997 |
| | | 4008.715099 | −7990.359714 | 6268.47690 | |

Table 12 shows the parameters and condition values for conditions (1)-(13) in accordance with the fourth embodiment of the invention. It can be seen from Table 12 that the lens assembly 4 of the fourth embodiment satisfies the conditions (1)-(13).

TABLE 12

| 1/(f × f1) | 0.58 | mm⁻² | R12/CT1 | 16.78 |
|---|---|---|---|---|
| \|R31 − (f1 + f3)\| | 11.05 | mm | (R21 + R22)/CT2 | −3.08 |
| \|f3/(Vd2/Vd3)\| | 12.09 | mm | \|CT3/f3\| | 0.02 |
| (f1/CT1) + (f2/CT2) | 12.82 | | (f1 + f2)/(CT1 + CT2) | 6.35 |
| (TTL + f)/R11 | 3.60 | | f/(CT1 + CT2 + CT3) | 1.42 |
| f/\sqrt{R11} | 1.28 | | f × TTL | 2.05 mm² |
| (f × f2)/TTL | 1.32 | mm | | |

The lens assembly 4 can meet the basic operation requirements when it is modified to only satisfies at least one of the conditions (1)-(13), the first lens having positive refractive power and a convex surface facing the object side, the second lens having positive refractive power and a convex surface facing the image side, the third lens having a concave surface facing the image side, and does not need other additional features and conditions.

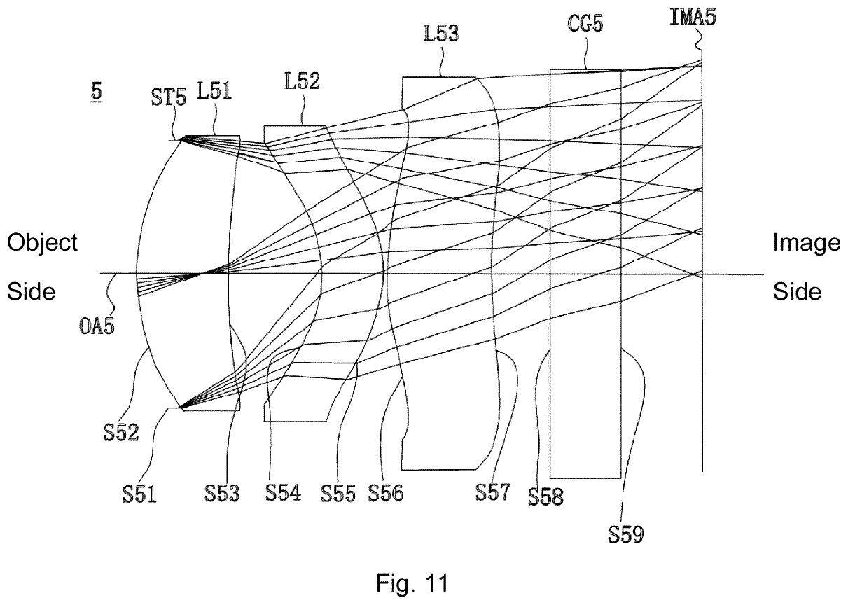

A detailed description of a lens assembly in accordance with a fifth embodiment of the invention is as follows. Referring to FIG. 11, the lens assembly 5 includes a stop ST5, a first lens L51, a second lens L52, a third lens L53, and a cover glass CG5, all of which are arranged in order from an object side to an image side along an optical axis OA5. In operation, the light from the object side is imaged on an image plane IMA5. According to the foregoing, wherein: the third lens L53 is with positive refractive power; both of the object side surface S58 and image side surface S59 of the cover glass CG5 are plane surfaces; and with the above design of the lenses, stop ST5, and at least one of the conditions (2)-(15) satisfied, the lens assembly 5 can have an effective decreased f-number, an effective decreased total lens length, and an effective corrected aberration.

Table 13 shows the optical specification of the lens assembly 5 in FIG. 11.

TABLE 13
Effective Focal Length = 1.127 mm F-number = 1.4
Total Lens Length = 1.684 mm Field of View = 59.7 degrees

| | Radius of | | | | Effective | |
|---|---|---|---|---|---|---|
| Surface | Curvature | Thickness | | | Focal | |
| Number | (mm) | (mm) | Nd | Vd | Length (mm) | Remark |
| S51 | ∞ | −0.120 | | | | ST5 |
| S52 | 0.709 | 0.278 | 1.671 | 19.243 | 1.443 | L51 |
| S53 | 2.540 | 0.281 | | | | |
| S54 | −0.346 | 0.183 | 1.671 | 19.243 | 3.060 | L52 |
| S55 | −0.356 | 0.017 | | | | |
| S56 | 1.250 | 0.306 | 1.661 | 20.382 | 13.213 | L53 |
| S57 | 1.330 | 0.175 | | | | |
| S58 | ∞ | 0.210 | 1.517 | 64.167 | | CG5 |
| S59 | ∞ | 0.235 | | | | |

The definition of aspheric surface sag z of each aspheric lens in Table 13 is the same as that of in Table 1, and is not described here again.

In the fifth embodiment, the conic constant k and the aspheric coefficients A, B, C, D, E, F, G of each aspheric lens are shown in Table 14.

TABLE 14

| Surface | | A | B | C | |
|---|---|---|---|---|---|
| Number | k | E | F | G | D |
| S52 | 1.330697 | 0.10978208 | −10.99945 | 83.286352 | −309.08256 |
| | | 0 | 0 | 0 | |
| S53 | 0 | 0.55260637 | −10.966582 | 124.45131 | −460.27221 |
| | | 0 | 0 | 0 | |
| S54 | −0.3775499 | 4.1142376 | 1.0036648 | 76.880887 | −104.10139 |
| | | 0 | 0 | 0 | |
| S55 | −5.496162 | −4.8835734 | 34.238142 | −80.993678 | 76.54611 |
| | | 0 | 0 | 0 | |
| S56 | 4.521712 | 2.8416363 | −85.084278 | 1012.8251 | −7236.5314 |
| | | 29621.638 | −63969.425 | 54045.602 | |
| S57 | 3.292374 | −2.3470545 | 6.4937016 | −1.3375013 | −185.37052 |
| | | 855.37308 | −1623.4583 | 1049.6537 | |

Table 15 shows the parameters and condition values for conditions (2)-(15) in accordance with the fifth embodiment of the invention. It can be seen from Table 15 that the lens assembly 5 of the fifth embodiment satisfies the conditions (2)-(15).

TABLE 15

| R12/CT1 | 9.14 | \|R31 − (f1 + f3)\| | 13.41 | mm |
|---|---|---|---|---|
| (R21 + R22)/CT2 | − 3.84 | \|f3/(Vd2/Vd3)\| | 13.40 | mm |
| \|CT3/f3\| | 0.023 | (f1/CT1) + (f2/CT2) | 21.91 | |
| (f1 + f2)/(CT1 + CT2) | 9.77 | (TTL + f)/R11 | 3.96 | |
| f/(CT1 + CT2 + CT3) | 1.47 | f/\sqrt{R11} | 1.34 | |
| f × TTL | 1.90 mm² | (f × f2)/TTL | 2.05 | mm |
| R12/BFL | 4.10 | (f2 × f2)/(TTL/2) | 11.12 | mm |

The lens assembly 5 can meet the basic operation requirements when it is modified to only satisfies at least one of the conditions (2)-(15), the first lens having positive refractive power and a convex surface facing the object side, the second lens having positive refractive power and a convex surface facing the image side, the third lens having a concave surface facing the image side, and does not need other additional features and conditions.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens assembly comprising:
a first lens which is a meniscus lens with positive refractive power and comprises a convex surface facing an object side and a concave surface facing an image side;
a second lens which is with positive refractive power and comprises a convex surface facing the image side; and
a third lens which is with refractive power and comprises a concave surface facing the image side;
wherein the first lens, the second lens, and the third lens are arranged in order from the object side to the image side along an optical axis;
wherein the lens assembly satisfies following conditions:
$$0.4 {mm}^{- 2} \leq 1 / ( f \times f 1 ) \leq 0.6 {mm}^{- 2} ;$$
$$12 \leq ( f 1 / CT 1 ) + ( f 2 / CT 2 ) \leq 30 ;$$
wherein f is an effective focal length of the lens assembly, f1 is an effective focal length of the first lens, f2 is an effective focal length of the second lens, CT1 is an interval from an object side surface of the first lens to an image side surface of the first lens along the optical axis, and CT2 is an interval from an object side surface of the second lens to an image side surface of the second lens along the optical axis.

2. The lens assembly as claimed in claim 1, wherein the second lens is a meniscus lens and further comprises a concave surface facing the object side.

3. The lens assembly as claimed in claim 2, wherein the third lens is a meniscus lens and further comprises a convex surface facing the object side.

4. The lens assembly as claimed in claim 3, wherein the third lens is with positive refractive power.

5. The lens assembly as claimed in claim 3, wherein the third lens is with negative refractive power.

6. The lens assembly as claimed in claim 1, further comprising a stop disposed between the object side and the first lens, wherein the first lens, the second lens, and the third lens are aspheric lenses and made of plastic material.

7. The lens assembly as claimed in claim 1, wherein the lens assembly satisfies at least one of following conditions:
$$9 \leq R 12 / CT 1 \leq 17 ;$$
$$- 4 \leq ( R 21 + R 22 ) / CT 2 \leq - 2.5 ;$$
$$7 mm \leq \vert f 3 / ( Vd 2 / Vd 3 ) \vert \leq 23 mm ;$$
$$0.01 \leq \vert CT 3 / f 3 \vert \leq 0.05 ;$$
$$6 \leq ( f 1 + f 2 ) / ( CT 1 + CT 2 ) \leq 13 ;$$
$$1.2 \leq f / ( CT 1 + CT 2 + CT 3 ) \leq 1.9 ;$$
$$6 mm \leq \vert R 31 - ( f 1 + f 3 ) \vert \leq 22 mm ;$$
$$3 \leq ( TTL + f ) / R 11 \leq 4.5 ;$$
wherein f is the effective focal length of the lens assembly, f1 is the effective focal length of the first lens, f2 is the effective focal length of the second lens, f3 is an effective focal length of the third lens, R11 is a radius of curvature of the object side surface of the first lens, R12 is a radius of curvature of the image side surface of the first lens, R21 is a radius of curvature of the object side surface of the second lens, R22 is a radius of curvature of the image side surface of the second lens, R31 is the radius of curvature of an object side surface of the third lens, TTL is an interval from the object side surface of the first lens to an image plane along the optical axis, Vd2 is an Abbe number of the second lens, Vd3 is an Abbe number of the third lens, CT1 is the interval from the object side surface of the first lens to the image side surface of the first lens along the optical axis, CT2 is the interval from the object side surface of the second lens to the image side surface of the second lens along the optical axis, and CT3 is an interval from an object side surface of the third lens to an image side surface of the third lens along the optical axis.

8. A lens assembly comprising:
a first lens which is with positive refractive power and comprises a convex surface facing an object side;
a second lens which is with positive refractive power and comprises a convex surface facing an image side; and
a third lens which is with refractive power and comprises a concave surface facing the image side;
wherein the first lens, the second lens, and the third lens are arranged in order from the object side to the image side along an optical axis;
wherein the lens assembly satisfies following conditions:
$$0.4 {mm}^{- 2} \leq 1 / ( f \times f 1 ) \leq 0.6 {mm}^{- 2} ;$$
$$9 \leq R 12 / CT 1 \leq 17 ;$$
$$12 \leq ( f 1 / CT 1 ) + ( f 2 / CT 2 ) \leq 30 ;$$
wherein f is an effective focal length of the lens assembly, f1 is an effective focal length of the first lens, f2 is an effective focal length of the second lens, CT1 is an interval from an object side surface of the first lens to an image side surface of the first lens along the optical axis, CT2 is an interval from an object side surface of the second lens to an image side surface of the second lens along the optical axis, and R12 is a radius of curvature of the image side surface of the first lens.

9. The lens assembly as claimed in claim 8, wherein the third lens is a meniscus lens and further comprises a convex surface facing the object side.

10. The lens assembly as claimed in claim 9, wherein:
the first lens is a meniscus lens and further comprises a concave surface facing the image side; and
the second lens is a meniscus lens and further comprises a concave surface facing the object side.

11. The lens assembly as claimed in claim 9, wherein the third lens is with positive refractive power.

12. The lens assembly as claimed in claim 9, wherein the third lens is with negative refractive power.

13. The lens assembly as claimed in claim 8, wherein the lens assembly satisfies at least one of following conditions:
$$- 4 \leq ( R 21 + R 22 ) / CT 2 \leq - 2.5 ;$$
$$7 mm \leq \vert f 3 / ( Vd 2 / Vd 3 ) \vert \leq 23 mm ;$$
$$0.01 \leq \vert CT 3 / f 3 \vert \leq 0.05 ;$$
$$6 \leq ( f 1 + f 2 ) / ( CT 1 + CT 2 ) \leq 13 ;$$
$$1.2 \leq f / ( CT 1 + CT 2 + CT 3 ) \leq 1.9 ;$$
$$6 mm \leq \vert R 31 - ( f 1 + f 3 ) \vert \leq 22 mm ;$$
$$3 \leq ( TTL + f ) / R 11 \leq 4.5 ;$$
wherein f is the effective focal length of the lens assembly, f1 is the effective focal length of the first lens, f2 is the effective focal length of the second lens, f3 is an effective focal length of the third lens, R11 is a radius of curvature of the object side surface of the first lens, R21 is a radius of curvature of the object side surface of the second lens, R22 is a radius of curvature of the image side surface of the second lens, R31 is the radius of curvature of an object side surface of the third lens, TTL is an interval from the object side surface of the first lens to an image plane along the optical axis, Vd2 is an Abbe number of the second lens, Vd3 is an Abbe number of the third lens, CT1 is the interval from the object side surface of the first lens to the image side surface of the first lens along the optical axis, CT2 is the interval from the object side surface of the second lens to the image side surface of the second lens along the optical axis, and CT3 is an interval from an object side surface of the third lens to an image side surface of the third lens along the optical axis.

14. A lens assembly comprising:
a first lens which is with positive refractive power and comprises a convex surface facing an object side;
a second lens which is with positive refractive power and comprises a convex surface facing an image side; and
a third lens which is with refractive power and comprises a concave surface facing the image side;
wherein the first lens, the second lens, and the third lens are arranged in order from the object side to the image side along an optical axis;
wherein the lens assembly satisfies at least one of following conditions:
$$1.2 < f / \sqrt{R 11} < 1.5 ;$$
$$1.7 {mm}^{2} < f \times TTL < 2.8 {mm}^{2} ;$$
$$1.2 mm < ( f \times f 2 ) / TTL < 3.5 mm ;$$
$$4 < R 12 / BFL < 5 ;$$
$$10 mm < ( f 2 \times f 2 ) / ( TTL / 2 ) < 24 mm ;$$
wherein f is an effective focal length of the lens assembly, f2 is an effective focal length of the second lens, TTL is an interval from an object side surface of the first lens to an image plane along the optical axis, BFL is an interval from an image side surface of the third lens to the image plane along the optical axis, R11 is a radius of curvature of the object side surface of the first lens, and R12 is a radius of curvature of an image side surface of the first lens.

15. The lens assembly as claimed in claim 14, wherein:
the first lens is a meniscus lens and further comprises a concave surface facing the image side; and
the second lens is a meniscus lens and further comprises a concave surface facing the object side.

16. The lens assembly as claimed in claim 14, wherein the third lens is a meniscus lens and further comprises a convex surface facing the object side.

17. The lens assembly as claimed in claim 16, wherein the third lens is with positive refractive power.

18. The lens assembly as claimed in claim 16, wherein the third lens is with negative refractive power.

19. The lens assembly as claimed in claim 15, further comprising a stop disposed between the object side and the first lens, wherein the first lens, the second lens, and the third lens are aspheric lenses and made of plastic material.

20. The lens assembly as claimed in claim 14, wherein the lens assembly satisfies at least one of following conditions:
$$0.4 {mm}^{- 2} \leq 1 / ( f \times f 1 ) \leq 0.6 {mm}^{- 2} ;$$
$$9 \leq R 12 / CT 1 \leq 17 ;$$
$$- 4 \leq ( R 21 + R 22 ) / CT 2 \leq - 2.5 ;$$
$$7 mm \leq \vert f 3 / ( Vd 2 / Vd 3 ) \vert \leq 23 mm ;$$
$$0.01 \leq \vert CT 3 / f 3 \vert \leq 0.05 ;$$
$$12 \leq ( f 1 / CT 1 ) + ( f 2 / CT 2 ) \leq 30 ;$$
$$6 \leq ( f 1 + f 2 ) / ( CT 1 + CT 2 ) \leq 13 ;$$
$$1.2 \leq f / ( CT 1 + CT 2 + CT 3 ) \leq 1.9 ;$$
$$6 mm \leq \vert R 31 - ( f 1 + f 3 ) \vert \leq 22 mm ;$$
$$3 \leq ( TTL + f ) / R 11 \leq 4.5 ;$$
wherein f is the effective focal length of the lens assembly, f1 is the effective focal length of the first lens, f2 is the effective focal length of the second lens, f3 is an effective focal length of the third lens, R11 is a radius of curvature of the object side surface of the first lens, R12 is a radius of curvature of the image side surface of the first lens, R21 is a radius of curvature of the object side surface of the second lens, R22 is a radius of curvature of the image side surface of the second lens, R31 is the radius of curvature of an object side surface of the third lens, TTL is an interval from the object side surface of the first lens to an image plane along the optical axis, Vd2 is an Abbe number of the second lens, Vd3 is an Abbe number of the third lens, CT1 is the interval from the object side surface of the first lens to the image side surface of the first lens along the optical axis, CT2 is the interval from the object side surface of the second lens to the image side surface of the second lens along the optical axis, and CT3 is an interval from an object side surface of the third lens to an image side surface of the third lens along the optical axis.
